(19) United States
(12) Patent Application Publication
(10) Pub. No.: US 2009/0250849 A1
(43) Pub. Date: Oct. 8, 2009

(54) Method of manufacturing environmenetal protection container

(76) Inventor: Hsi-Ching Chang, Taichung (TW)

Correspondence Address: HSI-CHING CHANG, P.O.BOX 215, TAICHUNG, 40099, TW

(21) Appl. No.: 12/230,723

(22) Filed: Sep. 4, 2008

(30) Foreign Application Priority Data
Apr. 3, 2008 (TW) 097112362

(51) Int. Cl. B29C 49/64; B29C 49/04

(52) U.S. Cl. 264/550

(57) ABSTRACT

A method of manufacturing an environmental protection container includes the following steps: PLA (poly lactic acid) or biodegradable raw materials are made to become a film. The film is a film bundle or an extended roll. The film then is rolled up and placed into a mold to process with in-mold crystallization and modification. By using in-mold crystallization procedure, biodegradable molecules can resist heat to achieve 120 degree centigrade after modification. The crystallization procedure can be processed in the mold and the film can be directly stamped and formed according to required shapes after modification, thereby enhancing heat resistance and increasing environmental protection efficiency for the environmental protection container.

### FIELD OF THE INVENTION

The present invention relates to a method of manufacturing an environmental protection container that does not only provide the functions such as environmental protection and heat resistances, but also provides forming process and optimization heat resistance and environmental protection features.

### BACKGROUND OF THE INVENTION

Although a main body of a conventional environmental protection container is made of biodegradable raw materials, it still has some drawbacks. Glass transition temperature (Tg) of the finished goods made of biodegradable raw materials is about 58-70 degree centigrade. Heat resistance is not well and the finished goods are unable to be taken as a heating container.

The finished goods made of biodegradable raw materials are acquired through “injection molding”. Namely, the finished goods are injected and formed after plastic raw materials are melted.

In addition, in the manufacture technique, the biodegradable raw materials are not processed with modification. Consequently, the finished goods cannot resist heat, and easily produce embrittlement.

A conventional plastic container is formed by an air-pressure forming machine. The formation is that a film is softened through a heating machine. The softened film then is delivered to a formation machine. The formation machine is composed of an upper table and a lower table, wherein an upper pattern plate pushed by an upper cylinder is disposed under the upper table. A lower pattern plate pushed by a lower cylinder is disposed on the lower table. The mold is moved to be opened or closed through the upper and lower pattern plates respectively driven by the upper and lower cylinders and the film is formed through air-pumping and inflation so that the film is cut to become the finished goods after formation.

However, the formation is merely heated to enable the film to become soft, thereby stamping the film. The finished goods may not resist heat if the raw materials of manufacturing the finished goods are crystal plastic materials. The finished goods, which are made of biodegradable raw materials, manufactured by the above process can only resist heat at the temperature of 58-70 degree centigrade. The food containers used by consumers need to resist heat at 120 degree centigrade during microwave heating. The finished goods may not satisfy the market demands.

Accordingly, to overcome the foregoing shortcomings, the inventor(s) of the present invention based on years of experience in the related field to conduct extensive researches and experiments, and finally invented a method of manufacturing an environmental protection container.

### SUMMARY OF THE INVENTION

A primary object of the invention is to provide a method of manufacturing an environmental protection container that includes the following steps: first, an interior of the container is made of biodegradable pellets to become a film through an extruder in advance. The film is an outputted slice, and then is rolled up to become a roller body. Second, the film is placed into a mold that is heated to achieve 140-160 degree centigrade again to rearrange molecules before achieving melting point. The film then is solidified again through crystallization procedure to enhance intensity and tension of the biodegradable molecules. Third, the mold then is processed with air pumping and the film is processed with stamping formation and cut by setting in-mold crystallization time between 3 and 6 seconds. The film is therefore inflated and drawn from the mold to become the environmental protection container with heat resistance.

Other features and advantages of the present invention and variations thereof will become apparent from the following description, drawings, and claims.

### BRIEF DESCRIPTION OF THE DRAWINGS

FIG. 1 is a flow chart illustrating a method of manufacturing an environmental protection container according to a preferred embodiment of the invention.

### DETAILED DESCRIPTION OF THE PREFERRED EMBODIMENTS

Firstly, PLA (poly lactic acid) or biodegradable raw materials under semi-crystalline state has the material's equilibrium melting point (Tm) at 207 degree centigrade. The melting point of the real finished goods is about 170-180 degree centigrade and glass transition temperature (Tg) is about 50-65 degree centigrade. Therefore, to arrange the crystallized molecules of PLA or biodegradable raw materials in order, the present invention extrudes PLA or biodegradable raw materials to become a film. The film then is placed into a mold that is heated again to achieve 140-160 degree centigrade before achieving the melting point. The film is slowly cooled with 3-6 seconds after heating to enable PLA or biodegradable molecules to be solidified and crystallized once again, thereby simultaneously pressing and forming during mold heating.

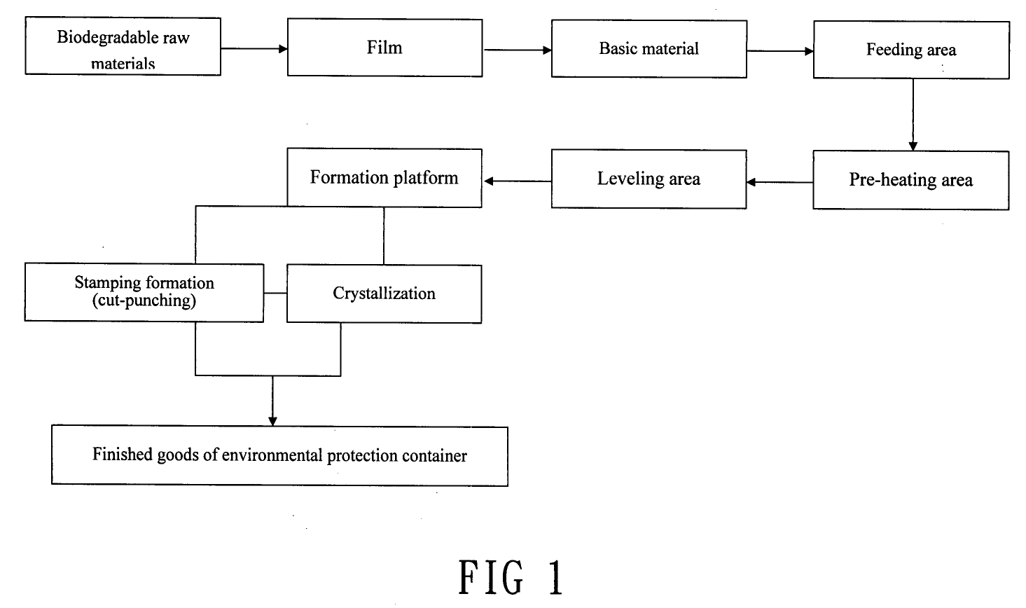

The method of the present invention is referred to FIG. 1 as a flow chart. The method includes the following steps: First, biodegradable raw materials are extruded by an extruder to become a continuous film. The film then is rolled up through a reel to become a bundle as a basic material. The basic material is disposed to a material rack in order to be conveyed to a feeding area. The material then is conveyed by a chain conveyor to a pre-heating area to enable the film to become soft. Secondly, the softened film is leveled at the leveling area. The leveled film then is conveyed to a formation platform. Thirdly, an upper mold and a lower mold of the formation platform are closed to continuously heat the film to achieve 140-160 degree centigrade to enable the film to be processed with in-mold crystallization procedure between 3 and 6 seconds. Simultaneously, the mold is processed with air-pumping and stamping formation. Cut-punching is synchronously carried on during the stamping formation. The upper and lower molds are opened with inflation after cooling at proper temperatures. The made-up articles then are drawn from the mold to become an environmental protection container with heat resistance.

To conclude the mentioned above, by using in-mold crystallization procedure, the molecules of biodegradable raw materials can be crystallized via sheet molding and heat transfer to proceed modification so that the finished goods can resist heat at 120 degree centigrade, thereby improving the actual function and novelty.

Although the features and advantages of the embodiments according to the preferred invention are disclosed, it is not limited to the embodiments described above, but encompasses any and all modifications and changes within the spirit and scope of the following claims.

What is claimed is:

1. A method of manufacturing an environmental protection container, an interior of the container that is made of biodegradable pellets to become a continuous film through an extruder in advance, the film being a slice that then is rolled up to become a roller body, the characterized in that: the film is placed into a forming mold, and the mold is continuously heated to achieve 140-160 degree centigrade to enable the film to proceed crystallization procedure again before achieving melting point, so that the film is solidified once again and molecules of the film are arranged in order, intensity and tension of biodegradable molecules are increased, the mold then is processed with air pumping and the film is processed with stamping formation by setting in-mold crystallization time between 3 and 6 seconds, the film is therefore inflated and drawn from the mold after cooling at proper temperatures.

2. The method of manufacturing an environmental protection container of claim 1, wherein the stamping formation is processed while cut-punching is carried on synchronously.
